(19) United States
(12) Patent Application Publication
(10) Pub. No.: US 2012/0223278 A1
(43) Pub. Date: Sep. 6, 2012

(54) SINGLE HUNG OR DOUBLE HUNG WINDOW OPENER

(76) Inventor: Arnold Kagan, Great Neck, NY (US)

(21) Appl. No.: 13/410,772

(22) Filed: Mar. 2, 2012

Related U.S. Application Data
(60) Provisional application No. 61/464,380, filed on Mar. 3, 2011.

(51) Int. Cl. B66F 15/00

(52) U.S. Cl. 254/130; 254/120

(57) ABSTRACT

A window opener that assists a user in raising the sash of a single hung or double hung window includes a base, a plurality of fulcrum pivot bars mounted on the base, each fulcrum pivot bar having a different height, and a lever arm. The lever arm is placed on an exposed end of one of the fulcrum pivot bars, and has a first axial end which is used for engaging the sash of the window, and an opposite second axial end which is grasped by the user. The user pushes down on the second axial end of the lever arm, and by a pivoting action on the fulcrum pivot bar, the second axial end which engages the sash raises the sash of the single hung or double hung window through mechanical advantage.

### CROSS-REFERENCE TO RELATED APPLICATIONS

This application is related to U.S. Provisional Patent Application Ser. No. 61/464,380, which was filed on Mar. 3, 2011, and is entitled “Double Hung Window Opener”, the disclosure of which is hereby incorporated by reference and on which priority is hereby claimed

### BACKGROUND OF THE INVENTION

1. Field of the Invention

The present invention relates to windows, especially single hung or double hung windows having a frame and a vertically sliding sash or sashes, and more specifically relates to devices used for assisting in opening windows.

2. Description of the Prior Art

It is well known that single hung or double hung windows consisting of a frame in which a vertically movable sash or sashes are situated can be difficult to open, especially for the elderly or the infirm. There often seems to be a problem when attempting to open these types of windows. The frame and sash are often made from wood. In the summer time, the wooden sashes and frame tend to swell, making it difficult to open and close the sashes within the frame. In the winter time, moisture between the frame and the sash may freeze, again making it difficult to open and close the window. The buildup of excess paint through many years tends to cause the sash and frame to stick. Weak persons, the elderly or the infirm often do not have the strength to open single hung and double hung windows.

### OBJECTS AND SUMMARY OF THE INVENTION

It is an object of the present invention to provide a device for assisting in the opening of single hung and double hung windows.

It is another object of the present invention to provide a single hung or double hung window opener that provides the user with a mechanical advantage to open the window.

It is yet another object of the present invention to provide a single hung or double hung window opener that provides the user with different leverages to assist the user in opening the window.

In accordance with one form of the present invention, a single hung or double hung window opener includes a base having a top surface, and a plurality of fulcrum pivot bars extending perpendicularly outwardly from the top surface of the base. The fulcrum pivot bars may have different lengths so that their heights above the top surface of the base vary. The single hung or double hung window opener further includes a lever arm in the form of an elongated member.

In operation, the base of the window opener is placed on the sill of a single hung or double hung window in proximity to the lower sash. The lever arm is placed on the free end of one of the fulcrum pivot bars at some point along the length of the lever arm. One axial end of the lever arm is positioned to engage the lower sash's bottom edge, lip, a handle affixed thereto, a sash molding or even a mullion, and the user grasps the opposite axial end of the lever arm with his hand. By the user forcing downwardly on the end of the lever arm which is grasped, the lever arm pivots on the free end of the fulcrum pivot bar on which it is placed, and due to the engagement of the opposite axial end of the lever arm with the window, forces the lower sash of the single hung or double hung window to open by moving vertically upwardly.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of the single hung or double hung window opener of the present invention and illustrating its use in opening a window.

FIG. 2 is a perspective view of the single hung or double hung window opener of the present invention.

FIG. 3 is a perspective view of one form of a lever arm forming part of the single hung or double hung window opener of the present invention, and further illustrating with dashed lines how the lever arm may be folded for storage.

FIG. 4 is a perspective view of an alternative version of the lever arm forming part of the single hung or double hung window opener of the present invention.

FIG. 5 is a cross-sectional view of the single hung or double hung window opener of the present invention placed adjacent a window and illustrating the operation of the window opener being used to open a window.

FIG. 6 is another cross-sectional view of the single hung or double hung window opener of the present invention placed adjacent a window and illustrating the operation of the window opener being used to open a window.

FIG. 7 is a perspective view of the single hung or double hung window opener of the present invention and illustrating how the window opener is used in elevating the sash of a single hung or double hung window.

FIG. 8 is another perspective view of the single hung or double hung window opener of the present invention and illustrating how the window opener is used in elevating the sash of a single hung or double hung window.

### DETAILED DESCRIPTION OF THE PREFERRED EMBODIMENTS

In the following detailed description, the window opener of the present invention will be referred to as a “double hung window opener”. However, it should be understood that the window opener is useable not only in opening double hung windows having two movable sashes, but also in opening single hung windows having a single movable sash.

Referring initially to FIG. 2 of the drawings, it will be seen that a double hung window opener 2 constructed in accordance with the present invention includes a supporting base 4, one or more fulcrum pivot bars 6 mounted on the base 4, and a lever arm 8. More specifically, the base 4 is a planar member having a bottom surface 10 and an opposite top surface 12, and is preferably rectangular in form. In one form, the base 4 is about three-quarters of an inch (¾″) in thickness, about three and one half inches (3½″) in width and about eleven inches (11″) in length. Rubber grommets (not shown) may be placed on the bottom surface 10 of the base 4 in proximity to the four corners thereof so that the base does not mar any furniture or the window sill 14 on which it is placed. Preferably, the base 4 is made of wood, although other materials, including a synthetic material, such as plastic, or even aluminum or another metal, may be used to form the base.

As shown in FIG. 2, one or more fulcrum pivot bars 6 are mounted on the base 4. More specifically, the fulcrum pivot bars 6 are also formed as elongated members that are affixed to the base 4 and extend perpendicularly outwardly from the top surface 12 of the base. Each fulcrum pivot bar 6 may be rectangular in overall shape, with one axial end 16 thereof resting on the top surface 12 of the base 4. Each fulcrum pivot bar 6 has an exposed second axial end 18 which is opposite to the end 16 that rests on and is affixed to the base 4.

Although it is envisioned to be within the scope of the present invention to include at least one fulcrum pivot bar 6, in a preferred form of the present invention, there are three or more fulcrum pivot bars 20, 22, 24 mounted on the base 4. The fulcrum pivot bars 20-24 may be situated on the base 4 in a side-by-side arrangement, adjacent fulcrum pivot bars being spaced apart from one another, as shown in FIG. 2. Alternatively, the fulcrum pivot bars 20-24 may be joined together, such as exemplified by the third fulcrum pivot bar 24 shown in FIG. 2, which bar has a stepped height.

In the embodiment of the double hung window opener shown in FIG. 2, there are three fulcrum pivot bars 20-24 mounted on the base 4. The first fulcrum pivot bar 20 has an axial length which is greater than that of the second or middle fulcrum pivot bar 22, and the second fulcrum pivot bar 22 has an axial length which is greater than that of the third fulcrum pivot bar 24. The third fulcrum pivot bar 24, as mentioned previously, has a stepped height, with a first portion 26 thereof having an elongated length which is greater than the length of the attached second portion 28 thereof Thus, each of the first, second and third fulcrum pivot bars 20-24 has a different height when measured from the top surface 12 of the base 4 from which they extend.

Even more preferably, the first fulcrum pivot bar 20 has a width of about two and one half inches (2½″), a thickness of about three-quarters of an inch (¾″) and a height above the top surface 12 of the base 4 of about seven inches (7″). The second fulcrum pivot bar 22 preferably has a width of about two and one half inches (2½″), a thickness of about three-quarters of an inch (¾″) and a height above the top surface 12 of the base 4 of about five and one quarter inches (5¼″). The third fulcrum pivot bar 24 has an overall width of about two and one half inches (2 ½″), which includes the first and second portions 26, 28 thereof, and a thickness of about three-quarters of an inch (¾″). The height of the first portion 26 of the third fulcrum pivot bar 24 above the top surface 12 of the base 4 is about three and a half inches (3½″), and the height of the second portion 28 of the third fulcrum pivot bar 24 above the top surface 12 of the base 4 is about one and three-quarter inches (1¾″). The width of the first portion 26 is about one and one-quarter inches (1¼″), and the width of the second portion 28 is about one and one-quarter inches (1¼″).

Like the base 4, the fulcrum pivot bars 6 may be formed from wood or another material, including a synthetic material, such as plastic, or even aluminum or another metal.

The double hung window opener 2 of the present invention further includes a lever arm 8, as shown in FIGS. 2-4. The lever arm 8 is an elongated member which may be rectangular in shape. The lever arm 8 includes a first axial end 30 and a second axial end 32 situated opposite the first axial end 30. Preferably, the lever arm 8 has a thickness of about three-quarters of an inch (¾″), a width of about one and one half inches (1½″) to about one and three-quarter inches (1¾″), and a length of about fifteen and one half inches (15½″). As will be described in greater detail, the lever arm 8 is placed on the free end 18 of one of the fulcrum pivot bars 6 at a point along the axial length of the lever arm 8, and is used to pry open the lower sash 34 of the single hung or double hung window 36 to assist in opening the window. The lever arm 8 may be formed from wood, a synthetic material, such as plastic, or aluminum or other metal.

An alternative form of the lever arm 8 is shown in FIG. 4 of the drawings. Here, the first axial end 30 of the lever arm 8 may be formed with a cylindrical portion 38 to define a handle so that it is easier to grasp by the user. The opposite second axial end 32 of the lever arm 8 may be formed with a sash engagement portion 40 which may be narrower in width and/or in thickness than the main or middle portion 42 or remainder of the lever arm 8 to facilitate the engagement of the lever arm 8, at the second axial end 32 thereof, with the sash 34 of the single hung or double hung window 36 to be opened. The tip 44 of the sash engagement portion 40 of the lever arm 8 may be angled or wedge-shaped in thickness to further enhance the ability of the lever arm 8 to engage the bottom of the sash 34 to open the window.

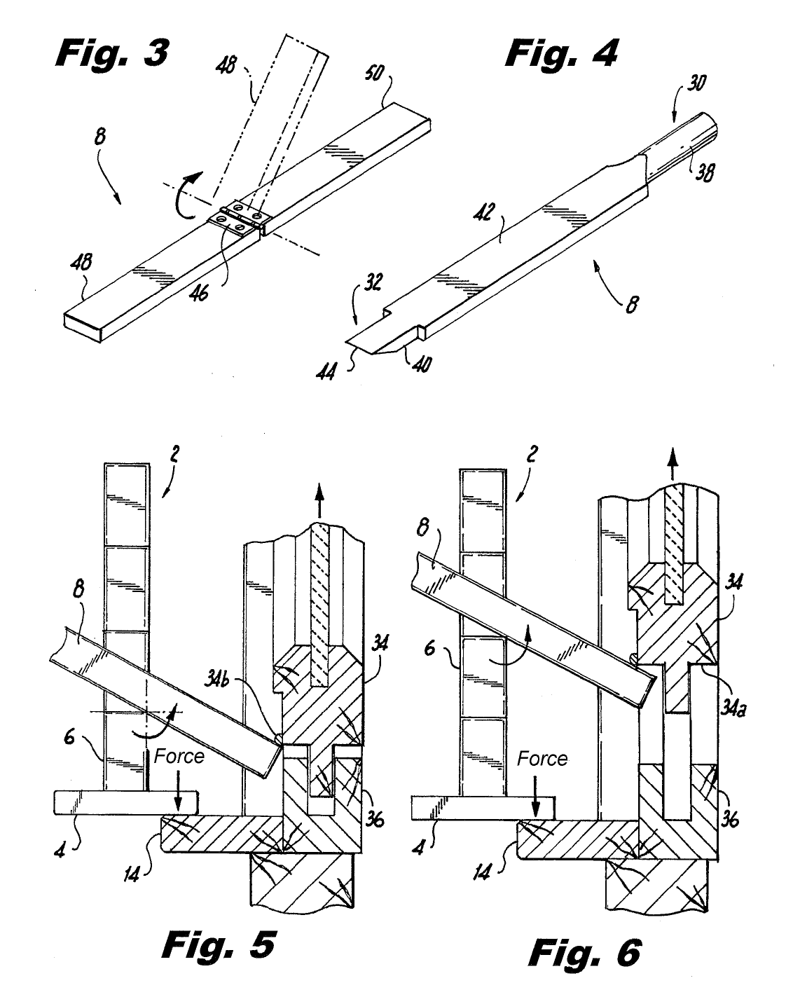

Another embodiment of the lever arm 8 of the present invention is shown in FIG. 3. In this particular embodiment, the lever arm 8 may be split into two portions which are joined together with a hinge 46 mounted on one side of the lever arm. Thus, the lever arm 8 is formed with a first segment 48 and a second segment 50, joined together by the hinge 46, so that one segment 48 may be folded on top of the other segment 50 for storage, and unfolded for use.

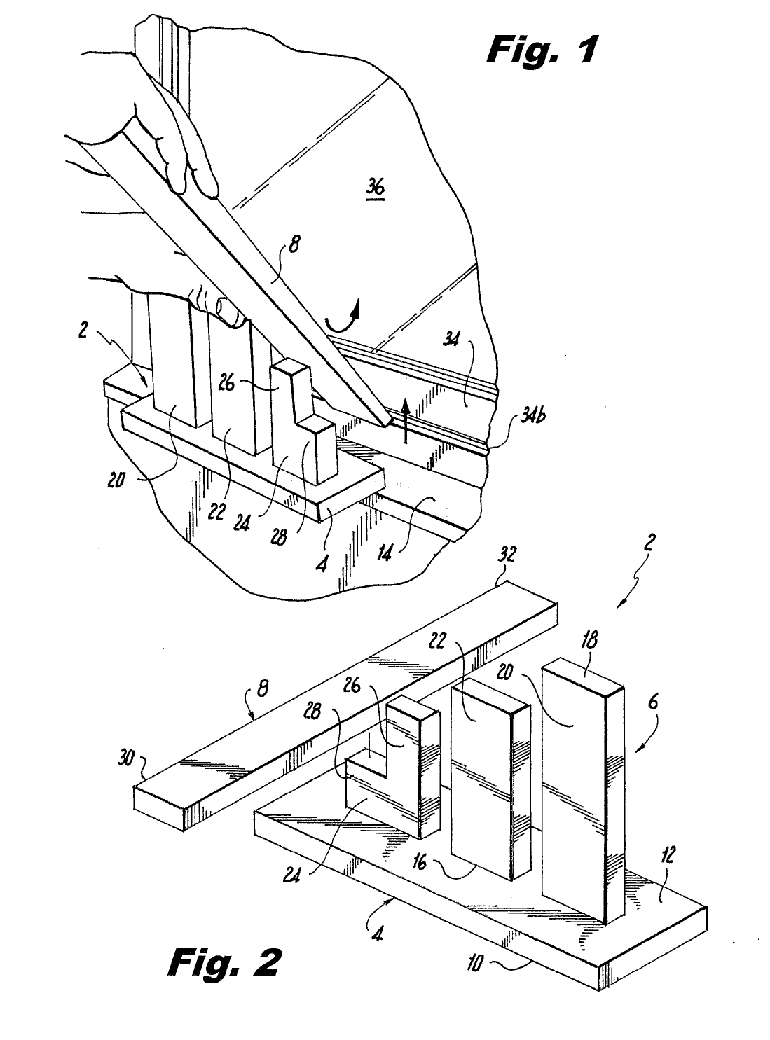

The operation of the double hung window opener 2 will now be described, and reference should be had to FIGS. 1 and 5-8 of the drawings. The base 4 of the double hung window opener 2 is placed on the sill 14 of the window 36 adjacent to the lower sash 34 to be opened. The lever arm 8 is placed on any desired fulcrum pivot bar 6, such as the first or second fulcrum pivot bar 20, 22, or the first portion 26 or the second portion 28 of the third fulcrum pivot bar 24. The first axial end 30 of the lever aim 8 is grasped by the user, and the opposite second axial end 32 of the lever arm is positioned to engage the sash's bottom edge 34a, a handle attached to the sash 34, a lip 34b protruding from the sash 34, a sash molding, or even a mullion 34c affixed to the sash 34. For single hung or double hung windows which are essentially closed, or depending upon the point or structure on the lower sash 34 which is to be engaged by the lever arm 8, it is envisioned that the user would place the lever arm 8 on the fulcrum pivot bar 6 having the lowest height. In the example of the double hung window opener 2 shown in FIG. 2, the user would place the lever arm 8 on the exposed axial end 18 of the second portion 28 of the third fulcrum pivot bar 24 which has the lowest height. The user may position the lever arm 8 on the exposed end 18 of a fulcrum pivot bar 6 anywhere along the length of the lever arm 8; however, it should be realized that the closer the user positions the lever arm 8 towards the second axial end 32, or sash engagement end 40, thereof on the exposed end 18 of the fulcrum pivot bar 6, the greater mechanical advantage the user will have in raising the window sash 34.

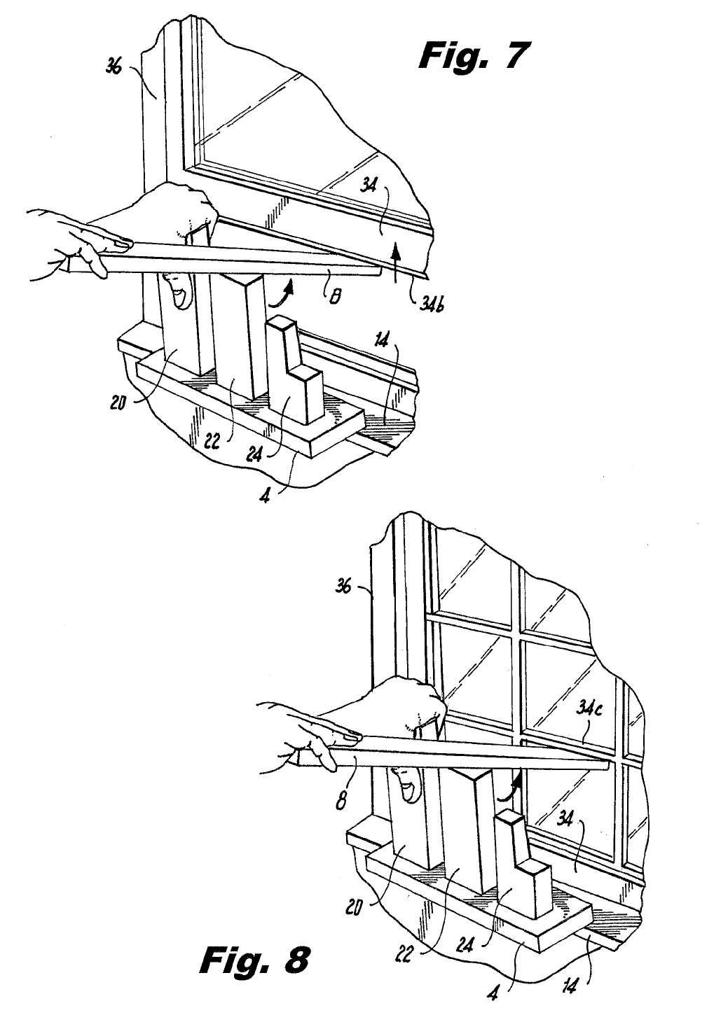

The user positions the second axial end 32 of the lever arm 8 in engagement with the lower sash's bottom edge or rail 34a, a handle positioned on the bottom rail of the sash 34, a lip 34b of the lower sash 34, a sash molding, or even a mullion 34c, and pushes downwardly on the first axial end 30 of the lever arm 8 which he grasps with his hand. The lever arm 8, resting on the exposed end 18 of one of the fulcrum pivot bars 6, pivots thereon to exert an upward force on the sash 34 of the single hung or double hung window 36 to at least partially raise the sash 34. Then, the user may reposition the lever aim 8 on a higher fulcrum pivot bar 6, such as the first portion 26 of the third fulcrum pivot bar 24 of the double hung window opener 2, such as shown in FIG. 1. Now, since the sash 34 is partially raised, the user may place the second axial end 32 of the lever arm 8 on the same lip 34b, handle, molding or other portion of the sash 34 which he engaged previously to raise the sash further, or he may engage the bottom edge 34a of the partially raised sash 34, and again pushes downwardly on the first axial end 30 of the lever arm 8 which he grasps. The lever arm 8 pivots on the fulcrum pivot bar 6 on which it is resting to force the sash 34 upwardly even further. The user may continue to switch to higher fulcrum pivot bars 6, such as the second fulcrum pivot bar 22 or the first fulcrum pivot bar 20, and, using the mechanical advantage provided by the lever arm 8, raise the sash 34 of the single hung or double hung window 36 even further to a desired height, as shown in FIGS. 7 and 8.

When the double hung window opener 2 is not being used, the lever 8 arm may be folded and placed on the base 4 for storage.

The dimensions of the base 4, fulcrum pivot bars 6 and the lever arm 8 are described herein as preferred embodiments; however, it is envisioned to be within the scope of the present invention to form these components with different dimensions. For example, for even greater mechanical advantage, the lever arm 8 may be formed with a length of about nineteen and one half inches (19½″) for use, for example, with heavier sashes. Also, the lengths of the fulcrum pivot bars 6 may vary depending on the dimensions of the single hung or double hung window 36.

Although illustrative embodiments of the present invention have been described herein with reference to the accompanying drawings, it is to be understood that the invention is not limited to those precise embodiments and that various other changes and modifications may be effected herein by one skilled in the art without departing from the scope or spirit of the invention.

What is claimed is:

1. A window opener to assist in opening a single hung or double hung window having a frame and a sash movably mounted in the frame, the window opener comprising:
a base, the base having a top surface;
at least one fulcrum pivot bar, the at least one fulcrum pivot bar being an elongated member and having a first axial end and a second axial end situated opposite the first axial end, the at least one fulcrum pivot bar being mounted on the base and extending perpendicularly outwardly from the top surface of the base, the first axial end of the at least one fulcrum pivot bar being mounted on the base, and the second axial end of the at least one fulcrum pivot bar being exposed; and
a lever arm, the lever arm being formed as an elongated member and having a first axial end to be grasped by a user and a second axial end situated opposite the first axial end for engagement with the sash of the window.

2. A window opener as defined by claim 1, wherein the at least one fulcrum pivot bar includes a plurality of fulcrum pivot bars, the fulcrum pivot bars of the plurality of fulcrum pivot bars being situated in a side-by-side arrangement and extending perpendicularly outwardly from the top surface of the base, the fulcrum pivot bars of the plurality of pivot bars having different lengths so that each fulcrum pivot bar extends to a different height measured from the top surface of the base.

3. A window opener as defined by claim 2, wherein at least one fulcrum pivot bar of the plurality of fulcrum pivot bars is joined to another fulcrum pivot bar.

4. A window opener as defined by claim 2, wherein at least one fulcrum pivot bar of the plurality of fulcrum pivot bars is spaced apart from an adjacent fulcrum pivot bar.

5. A window opener as defined by claim 1, wherein the at least one fulcrum pivot bar includes at least a first portion and a second portion, the first portion having a greater length than the second portion, each of the first portion and the second portion having an exposed end, the height of the first portion of the at least one fulcrum pivot bar measured from the top surface of the base to the exposed end of the first portion being greater than the height of the second portion of the at least one fulcrum pivot bar measured from the top surface of the base to the exposed end of the second portion

6. A window opener as defined by claim 1, wherein the lever arm includes a first segment and a second segment, and a hinge interconnecting the first segment with the second segment, the lever arm being foldable at the hinge so that the first segment may be at least partially folded over the second segment at the hinge for storage.

7. A window opener as defined by claim 1, wherein the lever arm includes a handle portion at the first axial end thereof, and a sash engagement portion at the opposite second axial end thereof.

8. A window opener as defined by claim 7, wherein the handle portion of the lever arm includes a cylindrical portion for grasping by the user with his hand.

9. A window opener as defined by claim 7, wherein the lever arm includes a main portion having a first thickness, and wherein the sash engagement portion of the lever arm includes a flattened portion having a thickness which is less than that of the main portion of the lever arm.
